(19) United States
(12) Patent Application Publication
(10) Pub. No.: US 2026/0268154 A1
(43) Pub. Date: Sep. 10, 2026

(54) SYSTEM AND METHOD FOR ENHANCED AUTOMATIC PROMPT TUNING

(71) Applicant: Reviewvio, Inc. DBA Dandy, Irvine, CA (US)

(72) Inventors: Alejandro Bellini, Laguna Niguel, CA (US); Jeffrey Scott Graves, Las Vegas, NV (US)

(21) Appl. No.: 19/558,236

(22) Filed: Mar. 5, 2026

Related U.S. Application Data
(60) Provisional application No. 63/767,431, filed on Mar. 5, 2025.

(51) Int. Cl. G06N 3/092

(52) U.S. Cl. CPC G06N 3/092

(57) ABSTRACT

A system includes a memory and a processor. The processor can be configured to obtain a target text, obtain metadata associated with the target text, obtain a model prompt, based on the metadata associated with the target text, from a token source, obtain, from a generative artificial intelligence (AI) model, an output text based on the model prompt and utilize the output text to initiate action. The model prompt is selected based on an effectiveness score generated by a critic model correlating the model prompt with a user-defined performance metric.

### CROSS-REFERENCE TO RELATED APPLICATION(S) AND CLAIM OF PRIORITY

This application claims priority under 35 U.S.C. § 119(e) to U.S. Provisional Patent Application No. 63/767,431 filed on Mar. 5, 2025. The above-identified provisional patent application is hereby incorporated by reference in its entirety.

### TECHNICAL FIELD

This disclosure relates generally to artificial intelligence and machine learning, and more specifically, to systems and methods for automatically generating and iteratively improving machine-generated prompts for a large language model (LLM) powered system according to a user-defined performance metric.

### BACKGROUND

Generative artificial intelligence tools, including text generation tools which utilize transformer-based models (for example, large language models (“LLMs”)) which can perform autoregressive generation to take an initial input, and which iteratively call the transformer model to predict a sequence of words comprising a textual output, have improved significantly across multiple dimensions of measured performance. Generative transformer-based models are deeper than ever and trained on unprecedentedly large data sets. Despite these improvements in depth and the distribution of inputs in the training set, the quality of the predicted outputs provided by any generative model necessarily depends, in significant part, on the quality of the prompt provided as an input. In simpler terms, for any large language model, the limits of what can be accomplished with the model depend, in significant part, on the extent to which suitable prompts for the model can be discovered and provided to the model.

As skilled artisans will appreciate, the size, complexity and structure of current LLMs (for example, ChatGPT 3.5 comprises a network of approximately 176 billion neurons and distributed across 96 hidden layers) is such that it is not generally possible to predict a prompt comprising the sequence of tokens that provides generative outputs which maximize one or more quality metrics for textual output. In cases where the metrics for the quality of the textual outputs are not defined during the development of the model, such as when the LLM is integrated as a component of a larger system, the search for suitable prompts proceeds heuristically or unsystematically. Further, in many cases, such large-scale LLMs are closed systems, which users are not able to tune or retrain on training sets which specify user-defined performance metrics as considered parameters of the model.

Accordingly, developing systems and methods for generating and refining sequences of input tokens (i.e., prompts) to tune and optimize one or more user-defined performance metrics remains a source of technical challenges and opportunities for improvement in the art.

### SUMMARY

This disclosure provides systems and methods for iteratively optimizing sequences of input tokens (i.e., prompts) for transformer-based and large language models to obtain outputs optimized for one or more user-defined performance metrics.

In a first embodiment, a system includes a memory and a processor. The processor can be configured to obtain a target text, obtain metadata associated with the target text, obtain a model prompt, based on the metadata associated with the target text, from a token source, obtain, from a generative artificial intelligence (AI) model, an output text based on the model prompt and utilize the output text to initiate action. The model prompt is selected based on effectiveness score generated by a critic model correlating the model prompt with a user-defined performance metric.

In a second embodiment, a method, includes at an apparatus comprising a processor and a memory, obtaining a target text. The method further includes obtaining metadata associated with the target text, obtaining a model prompt, based on the metadata associated with the target text, from a token source, obtaining, from a generative artificial intelligence (AI) model, an output text based on the model prompt, and utilizing the output text to initiate action. The model prompt can be selected based on an effectiveness score generated by a critic model correlating the model prompt with a user-defined performance metric.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example of a first device which can operate either as a standalone device or as a client for refining model prompts according to this disclosure;

FIG. 2 illustrates an example of a server which can operate as a standalone device, a client, or a host of a system for refining model prompts according to this disclosure;

FIGS. 3A-3B illustrate examples of processing pipelines for performing prompt tuning according to a user-defined performance metric, according to embodiments of this disclosure;

FIG. 4 illustrates an example of a training pipeline for training a critic model according to embodiments of this disclosure; and

FIG. 5 illustrates operations of an example method for generating and utilizing model prompts optimized around a user-defined performance metric according to this disclosure.

### DETAILED DESCRIPTION

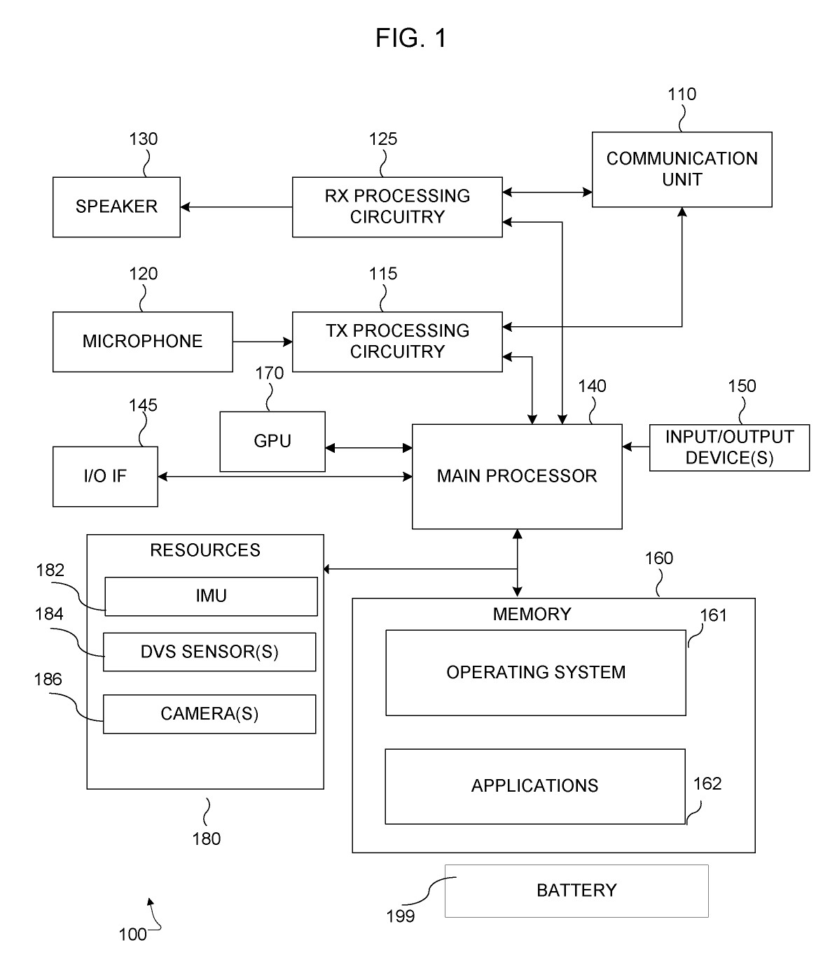

FIGS. 1 through 5, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged processing platform.

FIG. 1 illustrates a non-limiting example of a device 100, which can operate as a standalone platform, a client platform, or in some embodiments, as a host for refining input tokens according to this disclosure. According to various embodiments of this disclosure, device 100 could be implemented as one or more of a smartphone, a tablet, or a laptop computer. The embodiment of device 100 illustrated in FIG. 1 is for illustration only, and other configurations are possible. However, suitable devices come in a wide variety of configurations, and FIG. 1 does not limit the scope of this disclosure to any particular implementation of a device.

As shown in the non-limiting example of FIG. 1, the device 100 includes a communication unit 110 that may include, for example, a radio frequency (RF) transceiver, a BLUETOOTH transceiver, or a WI-FI transceiver, etc., transmit (TX) processing circuitry 115, a microphone 120, and receive (RX) processing circuitry 125. The device 100 also includes a speaker 130, a main processor 140, an input/output (I/O) interface (IF) 145, input/output device(s) 150, and a memory 160. The memory 160 includes an operating system (OS) program 161 and one or more applications 162.

Applications 162 can include web browsers, games, social media applications, applications for geotagging photographs and other items of digital content, virtual reality (VR) applications, augmented reality (AR) applications, operating systems, device security (e.g., anti-theft and device tracking) applications or any other applications which access resources of device 100 and can attempt to connect with machines on an outside network. According to some embodiments, the resources of device 100 include, without limitation, speaker 130, microphone 120, input/output devices 150, and additional resources 180.

The communication unit 110 may receive an incoming RF signal, for example, a near field communication signal such as a BLUETOOTH or WI-FI signal. The communication unit 110 can down-convert the incoming RF signal to generate an intermediate frequency (IF) or baseband signal. The IF or baseband signal is sent to the RX processing circuitry 125, which generates a processed baseband signal by filtering, decoding, or digitizing the baseband or IF signal. The RX processing circuitry 125 transmits the processed baseband signal to the speaker 130 (such as for voice data) or to the main processor 140 for further processing (such as for web browsing data, online gameplay data, notification data, or other message data). Additionally, communication unit 110 may contain a network interface, such as a network card, or a network interface implemented through software.

The TX processing circuitry 115 receives analog or digital voice data from the microphone 120 or other outgoing baseband data (such as web data, e-mail, or interactive video game data) from the main processor 140. The TX processing circuitry 115 encodes, multiplexes, or digitizes the outgoing baseband data to generate a processed baseband or IF signal. The communication unit 110 receives the outgoing processed baseband or IF signal from the TX processing circuitry 115 and up-converts the baseband or IF signal to an RF signal for transmission.

The main processor 140 can include one or more processors or other processing devices and execute the OS program 161 stored in the memory 160 in order to control the overall operation of the device 100. For example, the main processor 140 could control the reception of forward channel signals and the transmission of reverse channel signals by the communication unit 110, the RX processing circuitry 125, and the TX processing circuitry 115 in accordance with well-known principles. In some embodiments, the main processor 140 includes at least one microprocessor or microcontroller. According to certain embodiments, main processor 140 is a low-power processor, such as a processor which includes control logic for minimizing consumption of battery 199 or minimizing heat buildup in device 100.

The main processor 140 is also capable of executing other processes and programs resident in the memory 160. The main processor 140 can move data into or out of the memory 160 as required by an executing process. In some embodiments, the main processor 140 is configured to execute the applications 162 based on the OS program 161 or in response to inputs from a user or applications 162. Applications 162 can include applications specifically developed for the platform of device 100, or legacy applications developed for earlier platforms. The main processor 140 is also coupled to the I/O interface 145, which provides the device 100 with the ability to connect to other devices such as laptop computers and handheld computers. The I/O interface 145 is the communication path between these accessories and the main processor 140.

The main processor 140 is also coupled to the input/output device(s) 150. The operator of the device 100 can use the input/output device(s) 150 to enter data into the device 100. Input/output device(s) 150 can include keyboards, touch screens, mouse(s), track balls or other devices capable of acting as a user interface to allow a user to interact with device 100. In some embodiments, input/output device(s) 150 can include a touch panel, an augmented or virtual reality headset, a (digital) pen sensor, a key, or an ultrasonic input device.

Input/output device(s) 150 can include one or more screens, which can be a liquid crystal display, light-emitting diode (LED) display, an optical LED (OLED), an active-matrix OLED (AMOLED), or other screens capable of rendering graphics.

The memory 160 is coupled to the main processor 140. According to certain embodiments, part of the memory 160 includes a random-access memory (RAM), and another part of the memory 160 includes a Flash memory or other read-only memory (ROM). Although FIG. 1 illustrates one example of a device 100. Various changes can be made to FIG. 1.

For example, according to certain embodiments, device 100 can further include a separate graphics processing unit (GPU) 170 or a neural processing unit (NPU) for implementing one or more machine learning (ML) or artificial intelligence (AI) models, including, without limitation, generative models, or large language models.

According to certain embodiments, device 100 includes a variety of additional resources 180 which can, if permitted, be accessed by applications 162. According to certain embodiments, additional resources 180 include an accelerometer or inertial measurement unit (IMU) 182, which can detect movements of the electronic device along one or more degrees of freedom. Additional resources 180 include, in some embodiments, one or more dynamic vision sensors 184, and one or more cameras 186 (for example, complementary metal oxide semiconductor (CMOS) sensor type cameras) of device 100. According to various embodiments, DVS sensor(s) 184 comprises a pair of dynamic vision sensors spaced at a stereoscopically appropriate distance for estimating depth at over a field of depth of interest. According to some embodiments DVS sensor(s) 184 comprise a plurality of DVS sensors with overlapping, or partially overlapping fields of view.

According to various embodiments, the above-described components of device 100 are powered by battery 199 (for example, a rechargeable lithium-ion battery), whose size, charge capacity and load capacity are, in some embodiments, constrained by the form factor and user demands of the device. As a non-limiting example, in embodiments where device 100 is a smartphone, battery 199 is configured to fit within the housing of the smartphone and is configured not to support current loads (for example, by running a graphics processing unit at full power for sustained periods) causing heat buildup.

Although FIG. 1 illustrates one example of a device 100 for refining input tokens to a system built around an LLM or other AI/ML model for providing textual outputs, various changes may be made to FIG. 1. For example, the device 100 could include any number of components in any suitable arrangement. In general, devices including computing and communication systems come in a wide variety of configurations, and FIG. 1 does not limit the scope of this disclosure to any particular configuration. While FIG. 1 illustrates one operating environment in which various features disclosed in this patent document can be used, these features could be used in any other suitable system.

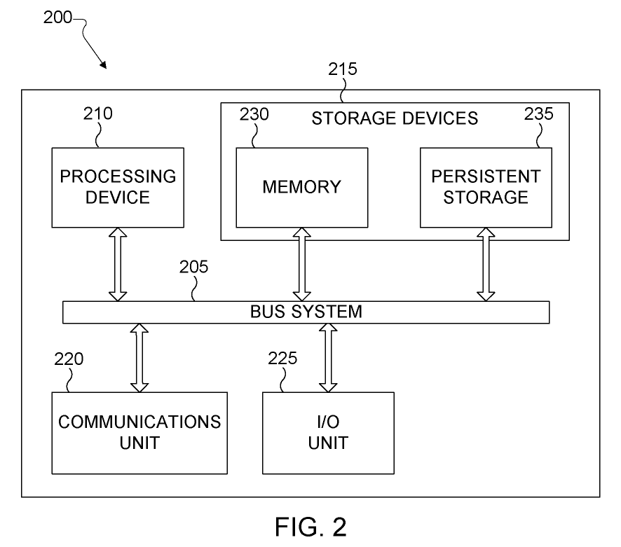

FIG. 2 illustrates an example of a server 200 that can be configured to act as one or more of a standalone platform for refining input tokens to an LLM, or as a client or host in a system of networked processing platforms for refining input tokens to an LLM according to certain embodiments of this disclosure. The embodiment of the server 200 shown in FIG. 2 is for illustration only and other embodiments could be used without departing from the scope of the present disclosure. According to certain embodiments, server 200 operates as a gateway for data passing between a device of a secure internal network (for example, device 100 in FIG. 1), and an unregulated external network, such as the internet.

In the example shown in FIG. 2, the server 200 includes a bus system 205, which supports communication between at least one processing device 210, at least one storage device 215, at least one communications unit 220, and at least one input/output (I/O) unit 225.

The processing device 210 executes instructions that may be loaded into a memory 230. The processing device 210 may include any suitable number(s) and type(s) of processors or other devices in any suitable arrangement. Example types of processing devices 210 include microprocessors, microcontrollers, digital signal processors, field programmable gate arrays, graphics processing units (GPUs), neural processing units (NPUs), application specific integrated circuits, and discrete circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random-access memory or any other suitable volatile or non-volatile storage device(s). The persistent storage 235 may contain one or more components or devices supporting longer-term storage of data, such as a ready only memory, hard drive, Flash memory, or optical disc.

The communications unit 220 supports communications with other systems or devices. For example, the communications unit 220 could include a network interface card or a wireless transceiver facilitating communications over the network 102. The communications unit 220 may support communications through any suitable physical or wireless communication link(s).

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

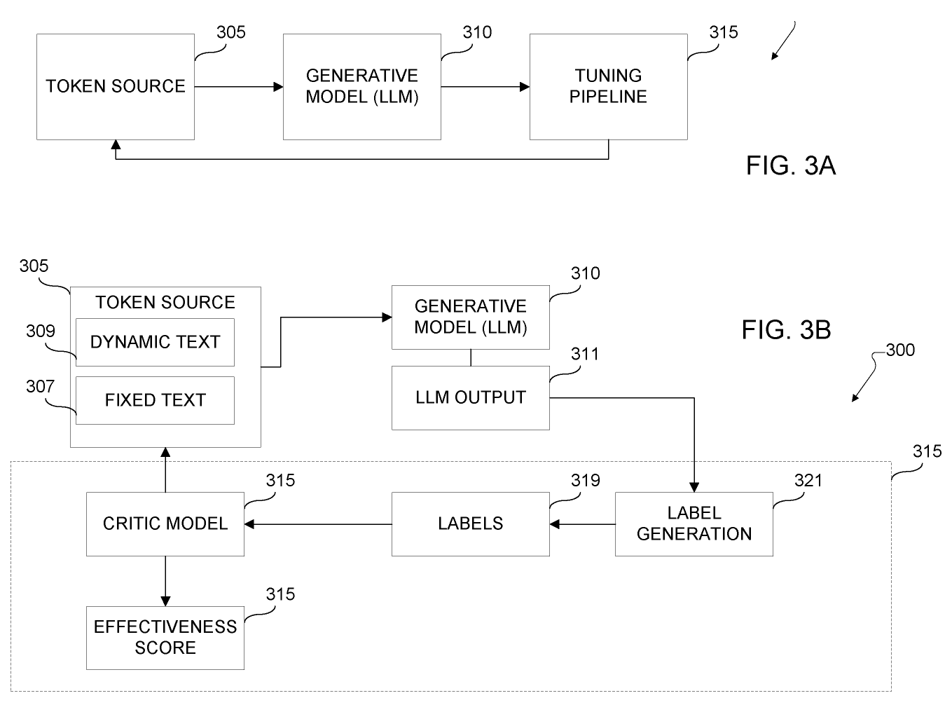

FIGS. 3A-3B illustrate, at a high level, two examples of a processing pipeline 300 according to some embodiments of this disclosure. For consistency and convenience of cross-reference, elements shown in both FIGS. 3A-3B are numbered similarly.

Processing pipeline 300 can, in some embodiments, be implemented at a single processing platform (such as electronic device 100 in FIG. 1 or server 200 in FIG. 2). Additionally, or alternatively, processing pipeline 300 can be implemented on a cloud computing platform, or across multiple networked processing platforms.

Referring to the illustrative example of FIG. 3A, processing pipeline 300 can include a token source 305, a large language model 310, and a tuning pipeline 315. Token source 305 comprises a library of prompts or a generative system for developing prompts. The prompts stored in, or generated by token source 305 comprise strings of tokens (for example, lines of text), which can be provided as inputs to large language model 310, which, based on the tokens in the prompt, embeds the input as an input vector for obtaining text outputs.

Large language model 310 can be one or more known LLMs, such as ChatGPT, GPT-4, Llama, PaLM, or Gemini. LLM 310 can, in some embodiments, utilize a transformer architecture. LLM 310 can embody, and be the result of, massive computational expense, having been trained on datasets comprising trillions of tokens, configured to consider billions of parameters, and comprising dozens of hidden layers. As skilled artisans will appreciate, LLM 310 is technically, and practically a “black box,” which has been trained to optimize performance metrics defined by its developers and cannot be modified or retrained optimize performance metrics of end-users. As discussed elsewhere herein, the large, and closed nature of LLM 310 implies that end-users looking to obtain outputs from LLM 310 which maximize user-defined performance metrics need to tune the set of tokens (i.e., the prompts) provided to LLM 310, as LLM 310 is not configured for end-user tuning.

Tuning pipeline 315 comprises a mechanism for labeling LLM outputs, and training one or more critic models to score sets of tokens based on their effectiveness according to a user-defined performance metric. As discussed herein, tuning pipeline 315 works around the transparency and inaccessibility issues (i.e., end-users generally being unable to retrain, optimize or reconfigure the model) inherent to many commercially available LLMs, and the fact that, while such LLMs are trained to maximize performance across a wide range of performance metrics, they are generally not trained to maximize performance across the user-defined performance metrics required for a specific application. Accordingly, embodiments according to this disclosure extend and enhance the functionality of a closed-system LLM by providing mechanisms by which prompts can be tuned to optimize a user-defined performance metric in a way that the LLM, by dint of its size, depth, or design, cannot be tuned.

FIG. 3B provides a second illustrative view of components of processing pipeline 300.

As shown in FIG. 3B, token source 305 comprises a generative system for creating, or a library of token strings (i.e., prompts) comprising at the following components. The prompts contain a fixed text component 307, comprising tokens providing information common to all prompts passed through processing pipeline 300, and a dynamic text component 309 comprising tokens associated with a specific scenario. In some embodiments, the dynamic text component can include tokens based on the outputs of one or more AI/ML predictions regarding one or more parameters of a text.

The tokens comprising fixed text 307 and dynamic text 309 are provided as a single prompt to LLM 310 with the object of obtaining a textual output maximizing one or more user-defined parameters.

As one, non-limiting example of using an LLM-powered system to obtain textual outputs maximizing one or more user-defined performance metrics, consider the case of a system configured to generate text for submission to an entity responsible for managing malicious, false, or otherwise non-compliant user reviews of products or businesses. As skilled artisans will appreciate, products and businesses often host websites inviting their customers and clients to post reviews describing their experiences with the host.

Used ethically, such review platforms can be of mutual benefit to both customers and businesses, in that, good or bad, customer reviews are often perceived as having greater credibility and objectivity than a business’s purchased advertising or self-generated promotional copy. Put differently, the medium of the online user review is perceived as unfiltered, authentic, and thus, more reliable than a business entity’s own statements about itself. However, user reviews present opportunities for malicious misuse, particularly by actors with access to LLMs and other tools allowing a single actor to create negative reviews at scale and emulating a variety of writing styles and voices, giving the misleading impression of large volumes of authentic negative customer experiences.

While it is often possible to get the hosts of review websites to take down reviews which are inauthentic, malicious or otherwise in violation of the review websites’ terms of use, victims of malicious or improper reviews seeking takedowns of the review face remain at a procedural disadvantage in that, while malicious content can be generated and posted with minimal disregard for truth, factual basis, or any effort at persuading a reader, a takedown request needs to be crafted with the goal of being accurate and persuasive to a reviewer of takedown requests. By contrast, malicious actors operate under no such constraints and can leverage LLMs and other tools for automating content production (sometimes referred to as “bots”) to produce and post untrue, harmful, or otherwise removable copy at scale.

More specifically, to be effective, a challenge to a negative review must be credible and correctly characterize the issues associated with a negative review. Put differently, challenges of the form “I request that the user review by ‘X’ giving my business five or fewer stars, and which contains at least one of: personal information, hate speech, irrelevant information, or profanity, be taken down,” are demonstrably ineffective. Instead, each instance of negative reviews as target text needs to be individually analyzed and made the subject of an instance-specific challenge request.

As noted elsewhere, modern LLMs are trained on enormous datasets, which can include training data across wide ranges of demographic variations, such that many prompts with permutations of age and role (for example, “describe a historical from the perspective of a 50 year old male”) comprise features which are in, or very close to the distribution of features in the training set. By contrast, text of takedown requests for a specific website is more likely to be out-of-distribution relative to the training set for a given LLM. Accordingly, submitting prompts with the stated goal of persuading an unknown individual to initiate a takedown of a particular item of content on a given website are likely to contain a significant number of tokens that are out-of-distribution from the training set of the LLM. Thus, direct prompts of the form “draft a persuasive takedown letter to the administrator of website ‘X’ to take down review ‘Y’,” contain sufficiently many out-of-distribution tokens that any textual output by the LLM to this will entail an unacceptable level of hallucination. In simpler terms, the training set of the LLM does not include any data regarding the persuasive effects of a letter to a website administrator regarding content that violates a specific terms of use agreement. Because of this, the LLM cannot reliably predict, based on connections within the model formed by its large, but still limited set, of training data, a sequence of textual outputs will have a calculable (to the LLM, at least) probability of achieving the result of taking down the offending review. Put differently, the data in the training set of the LLM does not include data correlating training texts with user-defined metrics regarding whether the texts initiated an action (in this case, takedown of an improper view) or the probability that a given item of text will initiate action. While it is possible that the LLM will “hallucinate well” or “hallucinate luckily,” and, for a given set of tokens in a prompt, produce a textual output that initiates the desired action. However, the fact remains that the LLM is not trained to predict, from a set of tokens, in a given prompt, the words of an output that will maximize the user-defined metric of a probability of initiating a desired action. Further, and as noted elsewhere herein, for many LLMs, the model is a closed system, and end-users are not able to train or retrain the model on data sets in which the user-defined performance metric is a parameter of the LLM.

Embodiments according to this disclosure, including tuning pipeline 315, solve the technical problem of obtaining, from an LLM textual inputs which optimize a user-defined performance metric, wherein the user-defined performance metric is out-of-distribution from the training set of the LLM, in cases where the LLM cannot be retrained or further trained on data correlating tokens to values of the user-defined performance metric. More specifically, tuning pipeline 315 can be configured to implement one or more labeling processes to generate labels 321 characterizing the outputs 311 of LLM 310 according to one or more user-defined metrics. By associating labels 319 and specific prompts from token source 305, tuning pipeline 315 trains a critic model 317 to output an effectiveness score 323 quantifying the extent to which, for a given a set of tokens (i.e., a prompt), the textual output 311 obtained from LLM 310 will is associated with a user-defined performance metric.

Returning to the previously-introduced example of automating the process of developing effective challenges to improper negative online reviews, in some embodiments, processing pipeline 300 is configured such that, for a given prompt comprising dynamic text 309 and fixed text 307 selected based on an analysis of a specific negative review, tuning pipeline 315 is trained to output an effectiveness score 323, which is a user-defined performance metric quantifying the extent to which textual output 311 obtained from providing the given prompt to LLM 310 will result in a takedown of the specific negative review. In this example, critic model 317 is trained to predict associations between prompts containing dynamic text 309 and fixed text 307, and the likely label assigned to LLM output 311.

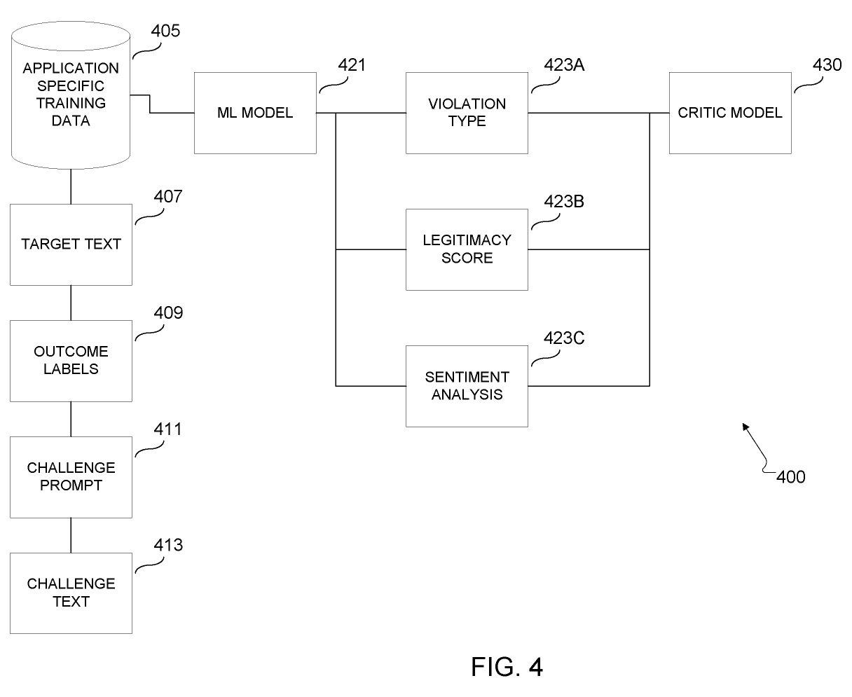

FIG. 4 illustrates an example of a training pipeline 400 for training a model (for example, critic model 317 in FIG. 3) to predict the performance of a textual output of a closed-box LLM (for example, LLM 310) according to a user-defined performance metric, in which the user-defined performance metric is a parameter not included in the distribution of parameters and tokens used to train the LLM, according to this disclosure.

While example training pipeline 400 is described with reference to embodiments of a critic model trained to predict, from features in a prompt to an LLM, the probability that the prompt will cause the LLM to provide a textual output resulting in a takedown of an improper online review, embodiments according to the present disclosure are not so limited, and training pipeline 400 can be adapted and utilized across a wide variety of applications.

Referring to the illustrative example of FIG. 4, training pipeline 400 comprises a corpus of application-specific training data 405. Corpus of application-specific training data 405 comprises a plurality (for example, ten thousand or more) of target texts 407 (for example, online negative reviews which were challenged). Corpus of application-specific training data 405 further comprises, for each target text of plurality of target texts 407, one or more user-defined output labels 409. The one or more user-defined output labels 409 associate each target text with one or more parameter not included in the training set of the LLM. Staying on the illustrative, non-limiting use case of a system using an LLM to automatically generate challenges to negative reviews, the one or more user-defined output labels 409 can include, without limitation, values indicating whether the challenge was successful (for example, “1” if the challenge resulted in a takedown, and “0” if the challenges was unsuccessful). Corpus of application-specific training data 405 can also include, for each target text of plurality of target texts 407, the challenge prompts 411 provided to the LLM (for example, LLM 310 in FIG. 3). In some embodiments, the fixed text (for example, fixed text 307) and dynamic text (for example, dynamic text 309) of the prompt can be included as part of corpus of application-specific training data 405. Further, in some embodiments, corpus of application-specific training data 405 includes, for each target text of plurality of target texts 407, a challenge text 413 (for example, LLM output 311) generated by the LLM.

Referring to the illustrative example of FIG. 4, training pipeline 400 further comprises a metadata acquisition stage 420. As shown in the figure, metadata acquisition stage 420 obtains metadata characterizing each target texts of plurality of target texts 407 according to one or more user-defined dimensions. For many applications (i.e., not just automatic generation of challenges to online review), the performance of the textual output from the LLM according to the user-defined performance metric can depend on the extent to which the textual output maps to the specific challenges posed by the target text. As noted elsewhere in this disclosure, for applications involving challenging an online review, the likelihood that a challenge will succeed is a function, at least in part, of how tailored the challenge is to the specifics of the target text. This is because, generic, open-form takedown requests have been confirmed as being consistently ineffective.

In this example, metadata acquisition stage 420 can include one or more machine learning models 421 (for example, classifier models, or large language models) which output predicted values for each target text 407 according to one or more user-defined parameters 423a-423c (skilled artisans that the number of user-defined parameters can be less than, or greater than, three). Remaining with the example of a system for tuning prompts for LLM-generated challenges to target text comprising improper online reviews, the values of user-defined parameters 423a-423c can include, values of a first parameter 423a classifying a target text as containing one or more recognized species of recommendation violations. In this example, values of first parameter could include TRUE/FALSE values for categories such as: “contains defamatory statement,” “contains profanity,” or “contains personal information.” Remaining with the example of optimizing automated challenges to negative online review, the values of second user-defined parameter 423b can include a weighted index of factors tending to show that the review comprises one or more indicia of illegitimacy (such as having been written by a machine, duplicative of other negative reviews, containing factual inaccuracies). Second user-defined parameter 423b can be one or more of a scalar score, or a set of binary classification results for a predefined set of indicia of illegitimacy. In this example, third user-defined parameter 423c can be a scalar or vector expressing an analysis of the sentiment in the target text (for example, a scalar value correlated to a star, or numerical rating).

Training pipeline 400 further comprises one or more critic models 430, which are trained to learn correlations between patterns in a target text, tokens (for example, prompts containing both fixed text 307 and dynamic text 309) in a prompt provided to the LLM for generating challenge text. In some cases, critic model 430 can be a Random Forest model, which iteratively builds multiple decision trees and aggregates predictions as to a probability that, for a target text embodying a given combination of extracted user-defined parameters, the tokens of a given prompt, if turned into text by the LLM, and the so-generated text is submitted as a review challenge, the review will be taken down.

During training, the prompts provided to critic model 430 can comprise multiple prompts using the same fixed text component (for example, fixed text 307 in FIG. 3) and different dynamic text components (for example, dynamic text 309 in FIG. 3).

Once initially trained, critic model 317 can be used as a component of a processing pipeline (for example, processing pipeline 300 in FIGS. 3A-B), and configured to analyze, for a given target text, the probability of a prompt whose tokens comprise combinations of fixed text (for example, fixed text 307 in FIG. 3B) and dynamic text 309 provided by token source 305, producing a textual output which succeeds according to a user-defined performance metric (for example, a challenge text causing the take down of a review). In this way, an initial set of effective prompts can be identified and further refined. For example, after identifying one high-performing combination of fixed text and dynamic text, token source 305, can, for target texts embodying similar combinations of extracted parameters, submit prompts containing a common core of fixed text and slightly varying dynamic text to the LLM. Once results of challenges based on the LLM outputs using the dynamic text variants are produced, submitted, and labeled according to one or more user-defined criteria (for example, whether the LLM-generated caused a review to be taken down), these results can form part of an enhanced training set. By iteratively experimenting with prompts embodying variants of the dynamic text in combination with a fixed text core, the effectiveness of the LLM as a tool for producing textual outputs that maximize a user-defined performance can be increased.

In the context of submitting challenges to improper online reviews, training a critic model (for example, critic model 317 in FIG. 3B) as described herein, and iteratively testing and refining the dynamic text component of the prompt has been shown to provide significant improvement in the effectiveness of the LLM as a tool for producing textual outputs optimized a user-defined parameter not included in the training data. For example, absent tuning, prompts to an LLM (ChatGPT-4) to draft a letter requesting the take down of a linked website had an average effectiveness score of 53%, meaning that “bare” prompts were able to produce text causing take downs in 53% of cases. After training a critic model on an initial training data set (i.e., an instance of application-specific training data 405 in FIG. 4), and excluding prompts which had an effectiveness score below 50%, iterative testing and tuning of dynamic text of prompts which had an initial effectiveness score greater than 50%, raised the overall effectiveness score of the set of tuned prompts to 83% (meaning that, in 83% of cases, the LLM output based on the refined prompt caused the target text to be taken down).

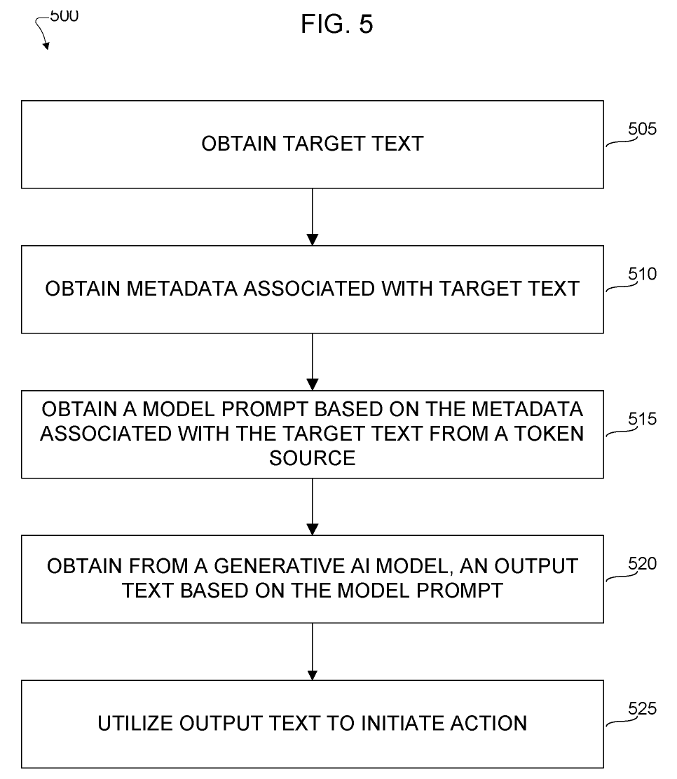

FIG. 5 illustrates operations of an example method 500 according to embodiments of this disclosure. The operations described reference to FIG. 5 can be performed at any processing platform (for example, the apparatus described with reference to FIGS. 1 and 2 of this disclosure) or combination of processing platforms.

Referring to the illustrative example of FIG. 5, at operation 505, a processor obtains a target text. According to certain embodiments, the target text embodies one or more features or parameters, which can be user-defined parameters. As discussed with reference to the examples herein, negative online reviews are one possible type of target text, and the features, or user-defined parameters of such target texts can include, without limitation, a class of policy violation, an authenticity score, and a sentiment analysis. Other user-defined features and parameters are possible and within the contemplated scope of this disclosure.

At operation 510, processor obtains metadata associated with the target text. In certain embodiments, the obtained meta comprises scalar or vector values of the one or more features or user-defined parameters characterizing aspects of interest of the target text. Continuing with the example of a system configured to generate using model prompts provided to a generative AI model, output text to initiate action comprising a takedown of an online review, the metadata obtained at operation 510 could include a vector comprising true/false values of whether one or more species of policy violations (for example, “contains abusive language” or “contains personal information”) is detected within a target text. The parameters can, in some embodiments, be outputs obtained by providing the target text to a suitably pretrained AI/ML model.

At operation 515, the processor obtains, based on the model prompt, from a token source (for example, token source 305 in FIGS. 3A and 3B) a model prompt selected, or generated, based upon the metadata obtained at operation 510. In some embodiments, the model prompt comprises at least a fixed text component (for example, fixed text 307) and a dynamic text component (for example, dynamic text 309). Further the tokens comprising the model prompt may be selected based on an effectiveness score generated by a critic model (for example, critic model 315) which has been trained to correlate model prompts with a user-defined performance metric (for example, a likelihood of a review being taken down). In some embodiments, the user-defined performance metric is out-of-distribution (i.e., not contained as a feature of the training set of the generative training model) of the generative training model (for example, generative model 310). Further, in some embodiments, the generative model is a closed system, which cannot be re-trained or tuned directly on user-provided training data.

At operation 520, the model prompt obtained at operation 515 is provided to a generative AI model (for example, an LLM) to obtain output text (for example, LLM output 311) based on the model prompt, and at operation 525, the operation 525, the output text is utilized (for example, by being posted or sent as a takedown request) to initiate action associated with one or more user-defined performance metrics.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A system, comprising:
a memory; and
a processor configured to:
obtain a target text;
obtain metadata associated with the target text;
obtain a model prompt, based on the metadata associated with the target text, from a token source;
obtain, from a generative artificial intelligence (AI) model, an output text based on the model prompt; and
utilize the output text to initiate action,
wherein the model prompt is selected based on an effectiveness score generated by a critic model correlating the model prompt with a user-defined performance metric.

2. The system of claim 1, wherein the processor is further configured to:
subsequent to utilizing the output text to initiate action, obtain feedback;
determine a value of the user-defined performance metric based on the obtained feedback;
label the model prompt according to the value of the user-defined performance metric;
add the labeled model prompt to a corpus of application specific training data; and
train the critic model based on the corpus of application-specific training data.

3. The system of claim 1, wherein the user-defined performance metric is a parameter which is out-of-distribution from parameters within a training set of the generative AI model.

4. The system of claim 1, wherein the generative AI model is a closed model and cannot be retrained by the system.

5. The system of claim 1, wherein the critic model is a random forest classifier.

6. The system of claim 1,
wherein the token source is a second generative AI model, configured to take as inputs, the metadata associated with the target text and output the model prompt.

7. The system of claim 1, wherein the model prompt comprises a fixed text component and dynamic text component.

8. The system of claim 7, wherein the processor is further configured to:
obtain a second target text;
obtain metadata associated with the second target text;
determine a threshold degree of similarity between the target text and the second target text based on a comparison between the metadata associated with the target text and the metadata associated with the second target text;
responsive to determining a threshold degree of similarity between the target text and the second target text, obtain a second model prompt, wherein the second model prompt comprises the fixed text component of the model prompt and a second dynamic component, wherein the second dynamic component is different from the dynamic component of the model prompt;
obtain, from the generative artificial intelligence (AI) model, a second output text based on the second model prompt;
utilize the second output text to initiate second action,
subsequent to utilizing the second output text to initiate action, obtain second feedback;
determine a second value of the user-defined performance metric based on the obtained second feedback;
label the second model prompt according to the second value of the user-defined performance metric; and
update the token source based on the second value of the user-defined performance metric.

9. The system of claim 8, wherein the processor is further configured to:
add the labeled second model prompt to a corpus of application specific training data; and
train the critic model based on the corpus of application-specific training data.

10. The system of claim 1,
wherein the target text comprises an online review,
wherein the output text comprises a request to take down the online review, and
wherein the user-defined performance metric comprises a binary value corresponding to whether the online review was taken down.

11. A method, comprising:
at an apparatus comprising a processor and a memory, obtaining a target text;
obtaining metadata associated with the target text;
obtaining a model prompt, based on the metadata associated with the target text, from a token source;
obtaining, from a generative artificial intelligence (AI) model, an output text based on the model prompt; and
utilizing the output text to initiate action,
wherein the model prompt is selected based on an effectiveness score generated by a critic model correlating the model prompt with a user-defined performance metric.

12. The method of claim 11, further comprising:
subsequent to utilizing the output text to initiate action, obtaining feedback;
determining a value of the user-defined performance metric based on the obtained feedback;
labeling the model prompt according to the value of the user-defined performance metric;
adding the labeled model prompt to a corpus of application specific training data; and
training the critic model based on the corpus of application-specific training data.

13. The method of claim 11, wherein the user-defined performance metric is a parameter which is out-of-distribution from parameters within a training set of the generative AI model.

14. The method of claim 11, wherein the generative AI model is a closed model and cannot be retrained by the apparatus.

15. The method of claim 11, wherein the critic model is a random forest classifier.

16. The method of claim 11,
wherein the token source is a second generative AI model, configured to take as inputs, the metadata associated with the target text and output the model prompt.

17. The method of claim 11, wherein the model prompt comprises a fixed text component and dynamic text component.

18. The method of claim 17, wherein the processor is further configured to:
obtain a second target text;
obtain metadata associated with the second target text;
determine a threshold degree of similarity between the target text and the second target text based on a comparison between the metadata associated with the target text and the metadata associated with the second target text;
responsive to determining a threshold degree of similarity between the target text and the second target text, obtain a second model prompt, wherein the second model prompt comprises the fixed text component of the model prompt and a second dynamic component, wherein the second dynamic component is different from the dynamic component of the model prompt;
obtain, from the generative artificial intelligence (AI) model, a second output text based on the second model prompt;
utilize the second output text to initiate second action,
subsequent to utilizing the second output text to initiate action, obtain second feedback;
determine a second value of the user-defined performance metric based on the obtained second feedback;
label the second model prompt according to the second value of the user-defined performance metric; and
update the token source based on the second value of the user-defined performance metric.

19. The method of claim 18, wherein the processor is further configured to:
add the labeled second model prompt to a corpus of application specific training data; and
train the critic model based on the corpus of application-specific training data.

20. The method of claim 11,
wherein the target text comprises an online review,
wherein the output text comprises a request to take down the online review, and
wherein the user-defined performance metric comprises a binary value corresponding to whether the online review was taken down.
